(19) United States
(12) Patent Application Publication
(10) Pub. No.: US 2014/0219592 A1
(43) Pub. Date: Aug. 7, 2014

(54) SYSTEM FOR GUIDING A VERTICAL SHAFT OF A ROTARY MACHINE, AND POWER-CONVERSION EQUIPMENT INCLUDING SUCH A SYSTEM

(71) Applicant: ALSTOM Renewable Technologies, Grenoble (FR)

(72) Inventors: Melet MATHIEU, St Nizier du Moucherotte (FR); Luc MELET, Moirans (FR); Emmanuel GODEC, Grenoble (FR)

(21) Appl. No.: 14/250,855

(22) Filed: Apr. 11, 2014

Related U.S. Application Data
(63) Continuation of application No. PCT/EP2012/070287, filed on Oct. 12, 2012.

(30) Foreign Application Priority Data
Oct. 13, 2011 (FR) 1159274

(51) Int. Cl. F16C 23/02

(52) U.S. Cl. CPC F16C 23/02; F16C 2360/00
USPC 384/257

(57) ABSTRACT

The invention relates to an adjustable system for guiding the rotation of a shaft about a vertical axis, including skids, each of which is provided with a surface for forming a bearing with the shaft. For each skid, a shim is provided with a cam surface, the outline of which, in a plane that is radial relative to the vertical axis of rotation, is inclined relative to said axis. Each skid directly engages, via a portion of the outer radial surface thereof, with the cam surface of the shim. Equipment for converting hydraulic power into electrical power according to the invention includes a wheel that is rotatably secured to a shaft guided by such an adjustable system.

### CROSS-REFERENCE TO RELATED APPLICATIONS

This application claims priority to PCT/EP2012/070287 filed Oct. 12, 2012, which claims priority to French application 1159274 filed Oct. 13, 2011, both of which are hereby incorporated in their entireties.

### TECHNICAL FIELD

The invention relates to an adjustable system for guiding a shaft in rotation about a vertical axis.

The invention can in particular be implemented with a hydraulic machine which can comprise a turbine, a pump or a pump turbine used in an installation for converting hydraulic energy into electrical energy or vice versa.

### BACKGROUND

In this type of installation, it is known to distribute several shoes over the circumference of a shaft rotating about a vertical axis. These shoes together form a bearing supporting the forces coming from the rotating shaft, thanks to the creation of a film of oil between the shaft and the bearing surface of the shoes. The radial position of these shoes must be precisely adjusted in order that the bearing retains a minimum oil film thickness with no risk of gripping or impact between the rotating shaft and the shoes. Moreover, when in rotation, the rotating shaft has a distortion which is more pronounced if the shoes are not held sufficiently rigidly in the radial direction.

This is in particular the case when the bearings are equipped, on their outer radial surface, with a swiveling system provided with an outer peripheral surface in the shape of a section of a sphere, designed to engage with a force take-up block having a cavity the bottom of which is also in the shape of a section of a sphere. The respective radii of the surfaces in the shape of a section of a sphere provided, on one hand, on the ball and, on the other hand, at the bottom of the cavity of the force take-up block are large, generally of the order of several meters for a turbine having a supporting shaft of diameter between 80 cm and 2 m. Creating surfaces in the shape of a section of a sphere of large radius is complex to implement, which increases the end cost of an installation incorporating such a mechanism.

Moreover, in the known systems, several parts are associated with one another so as to define the radial position of the shoes, specifically, for each shoe, a ball, a force take-up block, a slanting wedge and a fixed support member. This stacking of parts causes an accumulation of flexibilities, such that the rigidity of the set of shoes is not maximized. It results therefrom that relatively pronounced distortions of the assembly formed by the shaft and the bearing can be observed when a hydraulic machine is in operation, which makes it necessary to design the labyrinth wheel seals, which are provided in the vicinity of the flow region of the main water flow within the hydraulic machine, with large tolerances. This causes not inconsequential leaks from this main flow and therefore a loss of performance and of effective production of the hydraulic machine.

Similar problems arise, in a general manner, in vertical axis rotary machines. This is in particular the case for alternators having shoe bearings.

In the field of bearings in general, it is known from U.S. Pat. No. 1,880,353 to use shoes to support a shaft rotating about an axis of unspecified orientation. These shoes are each able to rotate about an axis defined by a threaded rod and bear, via a shoulder, against an inclined portion of a casing. The shoes are guided with little precision and there is a risk of the casing deforming under the effect of the radial forces exerted by the shoes.

### SUMMARY

It is these drawbacks which the invention intends more particularly to remedy by proposing an adjustable system for guiding a shaft of a machine, by means of which it is possible to obtain improved rigidity of the support of the shoes of this system and thus to limit the distortions of the shaft in use. It is also an object of the invention to reduce the transverse dimensions of the labyrinth wheel seals used in a hydraulic installation incorporating this guiding system. It is also an object of the invention to reduce the cost and to simplify the adjustment of the play of the shoe bearing with, as a consequence, assembly and maintenance times which reduce the machine downtime.

To that end, the invention relates to an adjustable system for guiding a shaft, in rotation about a vertical axis, this system comprising shoes, each provided with a surface designed to form a bearing with the shaft and, for each shoe, a wedge provided with a cam surface the profile of which, in a plane which is radial with respect to the vertical axis of rotation, is inclined with respect to this axis. According to the invention, each shoe bears directly, via a portion of its outer radial face, against the cam surface of the wedge, while each cam is provided with an oblong opening the largest dimension of which is parallel to the vertical axis of rotation and in which is housed a captive nut which is guided in translation by longitudinal edges of this opening and the position of which in the opening is controlled by means of a threaded rod in engagement with an internal tapping of the captive nut.

In the present description, the terms “axial” and “radial” are defined with respect to the vertical axis of rotation of the shaft for which the guiding system is intended. A direction is said to be axial if it is parallel to this axis, a surface is said to be axial if it is perpendicular to this axis. A direction is said to be radial if it is perpendicular to and secant with this axis. A surface is said to be radial if it is centered on this axis. A plane is said to be radial if it contains a radial direction and the axis of rotation.

By virtue of the invention, the position of each shoe, in a radial direction, is defined by the direct engagement between this shoe and the cam surface of the wedge, without it being necessary to use an articulation with a ball and a force take-up block as in the equipment of the prior art. The invention thus goes counter to the technique used in the systems comprising a ball having an outer surface in the shape of a section of a sphere in that, in these known systems, a sliding contact between the ball and the force take-up block is promoted. In contrast, the direct bearing produced in the invention, between the portion of the outer radial face of the shoe and the cam surface of the wedge, causes a possible peening of the surfaces bearing against one another, which is tolerated over the life of the hydraulic machine equipped with the adjustable guiding system of the invention. Moreover, guiding the shoes by means of the captive nut in the oblong opening is precise, while the elements for adjusting the position of the shoes are subjected to acceptable mechanical loads.

According to advantageous but not obligatory aspects, such a guiding system may incorporate one or more of the following features in any technically admissible combination:

the cam surface of each wedge makes it possible to adjust the radial position of the shoe bearing against this surface, by means of a vertical translation of the cam.

the aforementioned opening is advantageously a hole through the wedge from its cam surface to the opposite surface via which this wedge bears against the fixed member.

each shoe bears directly against the cam surface of the corresponding wedge, on either side of the opening of this wedge, in a horizontal direction.

each shoe is provided, on its outer radial face, with a shoulder which defines a localized direct bearing surface against the cam surface of the corresponding wedge.

the bearing surface of the shoulder is polygonal in shape, in particular square. As a variant, this bearing surface is circular in shape.

the shoulder is provided with an opening for receiving a part of the captive nut.

the directly bearing parts of a shoe and of the corresponding wedge are provided to be peened by one another when the guiding system is in use.

the system comprises a fixed force take-up ring, an inner radial surface of which, oriented toward the vertical axis of rotation, has channels cut into it, a wedge being held in each of these so as to be able to slide vertically.

the captive nut comprises a head which projects beyond the cam surface of the wedge and which is held in an opening of the shoe bearing against this surface.

the opening is created in the shoulder of the shoe and the localized direct bearing surface surrounds the mouth of the opening.

two orifices are created in the wedge, which orifices are aligned with the larger dimension of the oblong opening, while the threaded rod engages successively in a first orifice of these two orifices, in an inner tapping of the captive nut and in the second orifice.

the wedges, the captive nuts and the threaded rods associated with the various shoes are interchangeable.

### BRIEF DESCRIPTION OF THE DRAWINGS

The invention also relates to an installation for converting hydraulic energy into electrical energy, or vice versa, which comprises a wheel for a turbine, for a pump or for a pump turbine which is secured in rotation about a vertical axis with a shaft guided by shoes. According to the invention, this installation comprises a system for guiding a shaft as mentioned hereinabove.

The invention will be better understood and other advantages thereof will appear more clearly in light of the following purely exemplary description of an embodiment of a hydraulic installation and of a guiding system in accordance with the principle of the invention, with reference to the appended drawings, in which:

FIG. 1 is a schematic outline depiction, in axial section, of an installation according to the invention,

FIG. 2 is a perspective view, with partial cutaway, corresponding to the detail II in FIG. 1,

FIG. 3 is a larger-scale view of the detail III in FIG. 2,

FIG. 4 is an exploded perspective view of certain elements of a shoe guiding system according to the invention,

FIG. 5 is an outline section along the line V-V in FIG. 2, in a plane which is radial with respect to the axis of rotation of the wheel of the installation,

FIG. 6 is a section along line VI-VI of FIG. 5,

FIG. 7 is a section along line VII-VII of FIG. 5, and

FIG. 8 is a section along line VIII-VIII of FIG. 5.

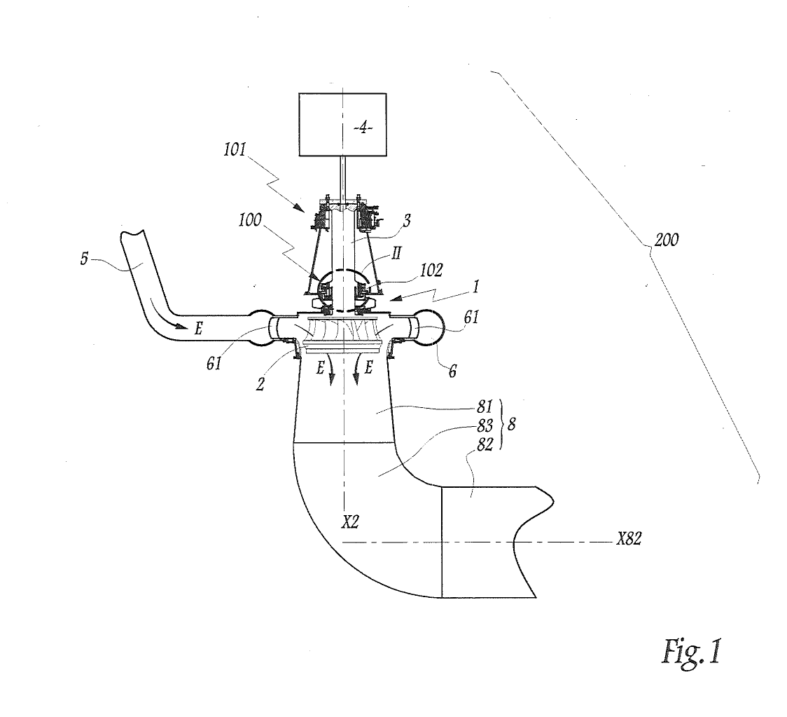

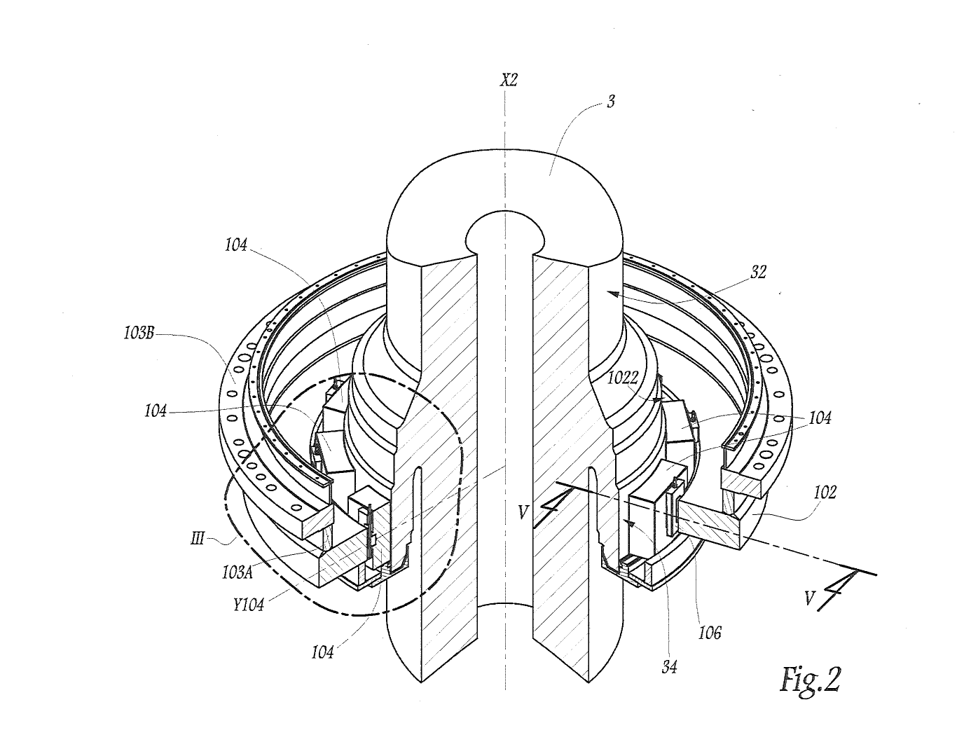

### DETAILED DESCRIPTION

The installation 200 shown in the figures comprises a turbine 1 of the Francis type, the wheel of which is designed to be set in rotation about a vertical axis X2 by a forced flow of water E from a water reservoir (not shown). A shaft 3 is secured in rotation about the axis X2 with the wheel 2. This shaft 3 is coupled to an alternator 4 which supplies an alternating current to a grid (not shown) as a function of the rotation of the wheel 2. The installation 200 thus makes it possible to convert the hydraulic energy of the flow E into electrical energy. The installation 200 may comprise one or more turbines 1 supplied from the same water reservoir.

According to another variant, the Francis turbine 1 can be replaced by a pump turbine which, when it is operating as a pump, is driven by an electric motor installed in place of the alternator 4 and converts the electrical energy into hydraulic energy of a flow set in motion by the pump wheel.

The flow E can be supplied to the wheel 2 by means of a supply duct 5 which extends between the water reservoir and a scroll casing 6 equipped with wicket gates 61 which regulate the flow E.

A duct 8 is provided downstream of the turbine 1 in order to draw away the flow E and return it to the bed of a river which supplies the water reservoir. This duct 8 is sometimes called a draft tube. The duct 8 comprises an upstream part 81 which is substantially vertical, frustoconical and centered on the axis X2, and a downstream part 82, centered on an axis X82, which is substantially horizontal. A 90° elbow 83 connects the parts 81 and 82 of the duct 8.

The shaft 3 is held in position with respect to a masonry structure (not shown) by means of two oil bearings 100 and 101 formed, respectively, around the upper and lower part of the shaft 3. As a variant, three oil bearings can be used to guide the shaft 3.

According to another variant, a hydraulic shoe bearing can be implemented, with a guiding system according to the invention, at the alternator 4.

The fixed structure of the installation 200 comprises a force take-up ring 102 which is arranged around the shaft 3 and which is secured to the masonry of the installation 200 (not shown). This force take-up ring 102 is made of metal and is welded to a hoop 103A which itself is welded to a strip 103B which is bolted to a flange (not shown) which in turn is attached to the masonry by other parts (not shown).

The inner radial surface of the ring 102, that is to say the surface of that ring which faces the axis X2, is given the reference 1022.

The outer radial surface 32 of the shaft 3 is stepped and comprises, close to the ring 102, a circumferential strip 34 about which there are arranged several shoes 104, the number of which varies depending on the size of the shaft 3. In the example of the figures, there are ten shoes.

Each shoe 104 comprises an inner radial surface 1042 which, in the assembled configuration of the installation 200, faces the axis X2 and which is in the shape of a section of a cylinder centered on this axis X2, with a radius substantially equal to or slightly greater than that of the strip 34. It is thus possible to define, between each shoe 104 and the surface 34, a part of the hydraulic bearing 100 within which a film of oil provides lubrication and force take-up for the shoe.

An axis which is radial with respect to the axis X2 and which passes through the center of the surface 1042 of a shoe 104 is given the reference Y104. Along its axis Y104, a shoe 104 extends between its surface 1042 and a planar outer radial surface 1044 which faces away from the axis X2.

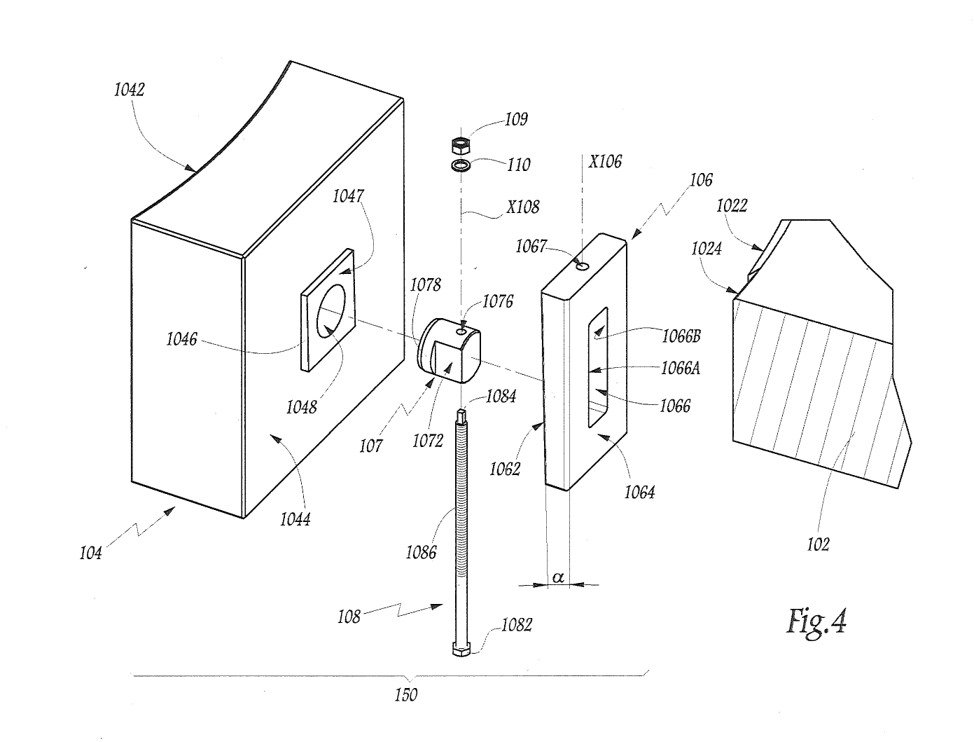

As shown more particularly in FIGS. 4 to 6, the surface 1044 of a shoe 104 is equipped with a shoulder 1046 which is in one piece with the remainder of the shoe 1044 and which projects with respect to the surface 1044. The shoulder 1046 is square in shape. As a variant, it can be circular or rectangular, or even have another polygonal shape.

That surface of the shoulder 1046 which faces away from the surface 1042, that is to say oriented radially toward the outside of a shoe 104 in the assembled configuration of the installation 200, is given the reference 1047.

An opening 1048, which is blind, of circular cross section and centered on the axis Y104, is created in the shoulder 1046. The surface 1047 surrounds the mouth of the opening 1048.

A wedge 106 is associated with each shoe 104. Each wedge 106 is of parallelepipedal overall shape, with an inner radial surface 1062 designed to face toward the axis X2 in the assembled configuration of the installation 200, and an outer radial surface 1064 which faces away from the surface 1062 and bears against the surface 1022 of the force take-up ring 102 in the assembled configuration of the installation 200.

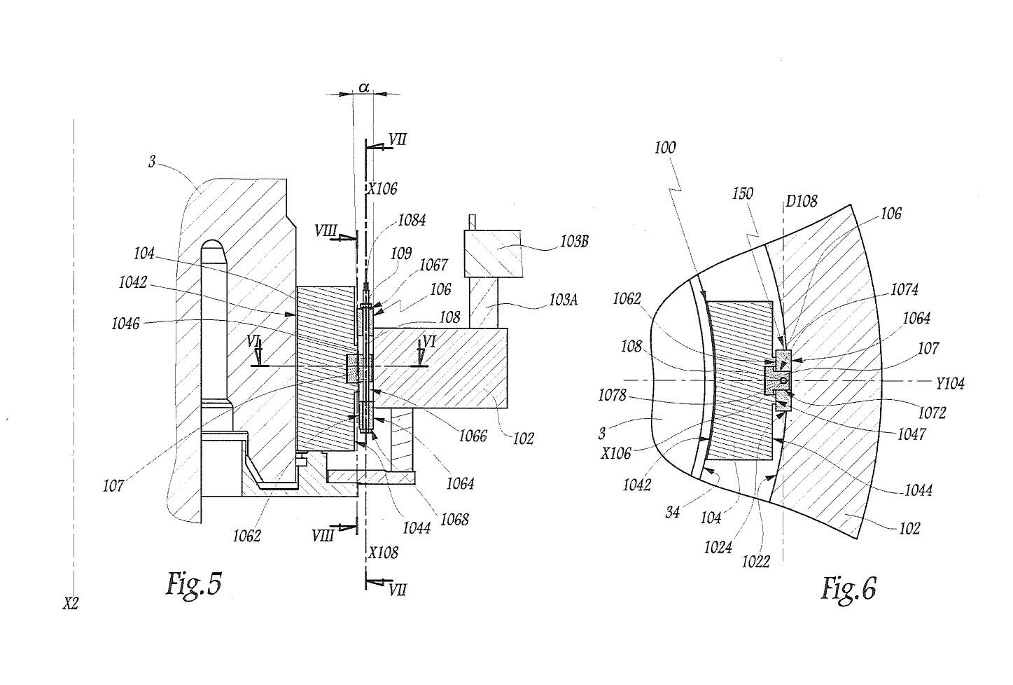

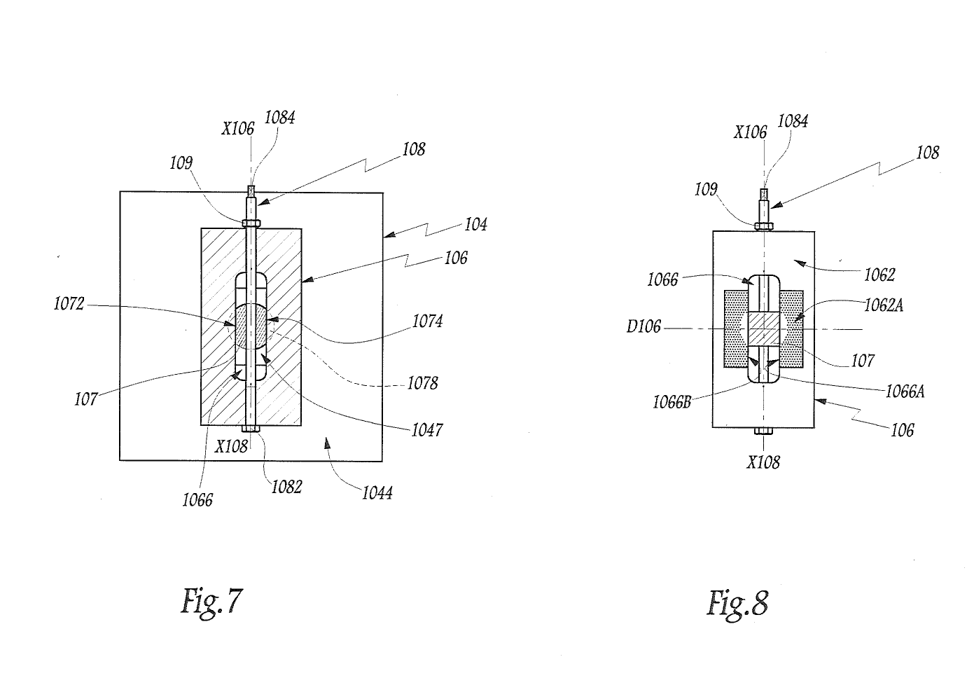

The surfaces 1062 and 1064 are planar but not parallel. Indeed, these surfaces enclose between them an angle α of less than 5°. The surfaces 1062 and 1064 are closer to each other at the bottom than the top when the wedge 106 is in place in the installation 200. More precisely, in the plane of FIG. 5 which is radial with respect to the axis X2, the profile of the surface 1062 is inclined with respect to this axis by the angle α. The surface 1062 converges toward the axis X2 toward the top of FIG. 5 while the surface 1064 is parallel to the axis X106. Thus, the surface 1062 of the wedge 106 forms a cam surface by means of which the radial position of the shoe 104 bearing against this surface can be adjusted by means of a vertical translation of the wedge 106. The wedge 106 may be termed a “slanting wedge”.

As is apparent from FIGS. 4 and 6, the surface 1022 has ten flat-bottom channels 1024 cut into it, a wedge 106 being held in each of these so as to be able to slide vertically.

There is created in the wedge 106, along the axis X106, an oblong opening 1066 the cross section of which is rectangular overall and the larger dimension of which is centered on an axis X106 parallel to the axis X2 in the assembled configuration and perpendicular to the axis Y104. The large edges of the opening 1066, which are parallel to the axis X106, are given the references 1066A and 1066B respectively. The opening 1066 is formed by a hole which passes through the wedge 106 from the surface 1062 to the surface 1064. As a variant, the hole 1066 can be replaced by a hollow opening which opens onto the surface 1062 but not onto the surface 1064.

The length of the hole 1066 along the axis X106 is designed such that the assembly 150 can be assembled and such that the play of the bearing can be adjusted.

Two orifices 1067 and 1068, which are aligned on the axis X106, are created in the wedge 106.

A nut 107 is mounted in a captive manner in the oblong opening 1066 of each wedge 106 and comprises two flat surfaces 1072 and 1074 which bear in a sliding manner on the sides 1066A and 1066B of this opening. The nut 107 is also provided with an internal tapping 1076 designed to engage with the threaded part 1086 of a screw 108, the head 1082 of which comes to abut against a lower surface of the wedge 106 in which the orifice 1068 opens. The other end 1084 of the screw 108 from the head 1082 has a square cross section, whereby it can be turned about the axis X106 when the screw 108 is in place in the orifices 1067 and 1068. It is thus possible, by turning the screw 108 to a greater or lesser extent about its longitudinal axis X108 which then coincides with the axis X106, to move, parallel to the axis X106, the wedge 106 with respect to the nut 107 which remains held in the oblong hole 1066. The edges 1066A and 1066B then interact with the flat surfaces 1072 and 1074 of the nut 107 in order to guide the wedge 106 in translation parallel to the axis X106. When the desired position of the wedge 106 along the axis X106 has been reached, it is possible to block the screw 108 in rotation by tightening a counternut 109 on the upper face of 106, via the intermediary of pressure on a self-locking washer 110.

The captive nut 107 comprises a head 1078 which projects from the surface 1062 of the wedge 106 and which is held in the opening 1048 of the associated shoe 104. Introducing the head 1078 in the opening 1048 ensures that the nut 107 does not slide vertically with respect to the shoe 104 when the wedge 106 slides about the nut 107 parallel to the axis X106. Thus, when the screw 108 is turned about its axis X108, which then coincides with the axis X106, the wedge 106 slides, upward or downward, along the surfaces 1047 and 1022 against which it bears in a sliding manner, respectively by its surfaces 1062 and 1064. During this sliding of the wedge 106 along the surface 1062, the shoe 104 bears directly against the surface 1062, at its surface 1047 which projects with respect to the rest of the surface 1044. More precisely, the surface 1047 bears locally against the surface 1062, on either side of the opening 1066 according to a horizontal direction D106 defined in the wedge 106 as perpendicular to the axis X106 and parallel to the surfaces 1062 and 1064.

As each shoe 104 bears directly against the surface 1062 of the associated wedge 106, which bears via its surface 1064 against the force take-up ring 102, the radial position of each shoe 104, that is to say its position along its axis Y104, is controlled precisely by the vertical translation of the corresponding wedge 106, without the manufacturing tolerances of the elements 104, 106 and 102 causing significant variations in position. Indeed, the inclined nature of the surface 1062 makes it possible to adjust the radial position of the shoe 104 by a vertical translation of the wedge 106. The direct bearing of the surfaces 1062 and 1047 against each other ensures transmission of forces without play and via planar surfaces. This represents a substantial step forward with respect to the known devices in which balls and force take-up blocks were inserted between the shoes and a part similar to the ring 102 of the invention.

To that end, it is noted that the head 1078 is mounted in the opening 1048 with a little play, such that any sliding of the shoe 104 around the head 1078, parallel to the axis Y104, is not likely to be limited to the point of interfering with the bearing of the surface 1047 against the surface 1062.

Since the surfaces 1047 and 1062 bear against one another, under substantial pressures, it is possible for peening to occur between these two surfaces, which is not problematic. To that end, the material of the elements 104, 106 and 107 can be chosen in order to tolerate, or even promote, such a peening. These parts can for example be made of carbon steel, in particular in the European grade S275, S355 or an equivalent thereof. In practice, the material for the wedge 106 is chosen such that its surface 1062 is peened under the effect of the contact with the shoulder 1046 of the associated shoe before the surface 1047 of this shoulder is itself peened. The material of the wedge 106 is thus softer than the material of the shoe 104. Indeed, in the event of substantial peening following vibrations or extraordinary forces, it is easier and less costly to change a wedge 106 than a shoe 104.

In FIG. 8, the grayed part of the surface 1062 represents a portion 1062A of this surface which has been peened under the effect of the pressure exerted by the surface 1047 of the shoulder 1046. In this case, the surface 1047 can also be peened. This is however not compulsory.

By means of the invention, the transmission of radial forces between the parts 104 and 106 occurs by means of the surfaces 1047 and 1062 which are planar, which is substantially easier to implement than in the event that surfaces in the shape of a section of a sphere must be produced, with large radii, as in the balls of the prior art.

The friction forces between the shaft 3 and each of the shoes 4 tend to cause these shoes to rotate about the axis X2. Indeed, these friction forces are transmitted from the surface 34 to the surface 1042. Thus, when the shaft 3 rotates in the clockwise direction in FIG. 6, the friction forces tend to drive the shoe 104 in the same direction, downward in this figure.

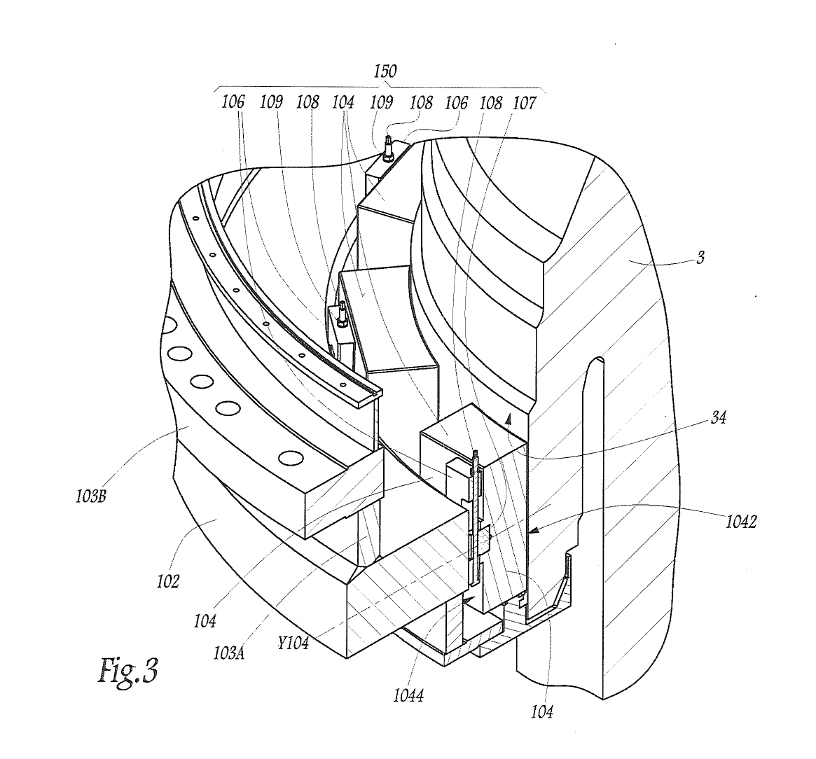

A straight line which is orthoradial with respect to the axis X2 and which passes through the axis X106 of the wedge 106 associated with each shoe 104 is given the reference D108. The tangential force exerted between the shaft 3 and the shoe 104 tends to move the nut 107 and the wedge 106 along the straight line 108, downward in FIG. 6. Indeed, this tangential force is transmitted by means of the contact pressure between the surfaces 1047 and 1062, the pressure of the head 1078 in the opening 1048 and the pressure of the flat surface 1072 bearing against the side 1066A of the opening 1066. This tangential force is taken up by the side of the channel 1024, wherein the surface 1064 of the wedge 6 rests against the bottom of the channel. When the shaft 3 rotates in the opposite direction, that it to say in the counterclockwise direction in FIG. 3, the wedge 6 comes to abut against the side of the channel 1024 which is partially visible in FIG. 4, at the junction between the surface 1022 and the channel 1024. Thus, whichever the direction of rotation of the shaft 3, the channels 1024 make it possible to block the wedges 106 in rotation about the axis X2 and thus to oppose the tangential forces within the bearing 100.

The invention is represented in the figures in the case of the surface 1047 being square in shape. As a variant, a circular shape can be envisaged as mentioned hereinabove. In this case, the shape of the portion 1062A of the surface 1062 changes accordingly. The shape of the shoulder 1046 and of the surfaces 1062 and 1064 is adapted depending on the magnitude of the forces to be transmitted.

At the same time, the shape of the head 1078 and of the opening 1048 can be altered. They may, as a variant, be of square or rectangular cross section.

The invention further presents an advantage in terms of safety. Indeed, even if, under the effect of vibration, the counternut 109 comes loose, to the point that the screw 108 is ejected from the orifices 1067 and 1068, there is no risk of the wedge 106 slipping entirely downward or upward as the captive nut 107 forms an end-stop for the vertical movement of the wedge 106. The shoe 104 cannot therefore come completely free and loose from the support 102 which, if that were to happen, would cause significant damage.

The system formed by the various shoes 104, the various wedges 106, the various captive nuts 107, the various rods 108 and their accessories 109 and 110 is given the reference 150. This system makes it possible to wedge the shoes 104 precisely and in an adjustable manner, by moving the nuts 107 in the oblong holes 1066, while remaining easy to manufacture and implement on the assembly site for the installation 200, with no requirement for on-site machining.

The invention makes it possible to envisage a standardization of the constituent elements 104 to 110 of the system 150 for guiding the shaft 3, which elements can be designed according to the magnitude of the forces to be transmitted.

It is moreover noted that the various elements 106, 107, 108, 109 and 110, associated with the various shoes 104, are interchangeable, which makes the installers' work easier when assembling the installation 200.

Finally, the constituent parts of the system 150 are easily accessible for testing, even after completed assembly, which makes monitoring and maintenance easier.

The invention can be implemented at the lower bearing 100, at the upper bearing 101 or at an intermediate bearing of the installation 200.

The invention is described hereinabove in the context of its implementation in a hydraulic installation. It can however be used in any vertical axis rotary machine having at least one shoe bearing. It can, for example, be an alternator or a motor.

1. An adjustable system for guiding a shaft, in rotation about a vertical axis, this system comprising shoes, each provided with a surface designed to form a bearing with the shaft and, for each shoe, a wedge provided with a cam surface the profile of which, in a plane which is radial with respect to the vertical axis of rotation, is inclined with respect to this axis, wherein each shoe bears directly, via a portion of its outer radial face, against the cam surface of the wedge, and in that each cam is provided with an oblong opening the largest dimension of which is parallel to the vertical axis of rotation and in which is housed a captive nut which is guided in translation by longitudinal edges of this opening and the position of which in the opening is controlled by means of a threaded rod in engagement with an internal tapping of the captive nut.

2. The system as claimed in claim 1, wherein the cam surface of each wedge makes it possible to adjust the radial position of the shoe bearing against this surface, by means of a vertical translation of the cam.

3. The system as claimed in claim 1, wherein the opening is a hole through the wedge from its cam surface to the opposite surface via which this wedge bears against the fixed member.

4. The system as claimed in claim 1, wherein each shoe bears directly against the cam surface of the corresponding wedge, on either side of the opening of this wedge, in a horizontal direction.

5. The system as claimed in claim 1, wherein each shoe is provided, on its outer radial face, with a shoulder defining a localized direct bearing surface against the cam surface of the corresponding wedge.

6. The system as claimed in claim 5, wherein the bearing surface of the shoulder is polygonal in shape, in particular square.

7. The system as claimed in claim 5, wherein the bearing surface of the shoulder is circular in shape.

8. The system as claimed in claim 5, wherein the shoulder is provided with an opening for receiving a part of the captive nut.

9. The system as claimed in claim 5, wherein the directly bearing parts of a shoe and of the corresponding wedge are provided to be peened by one another when the guiding system is in use.

10. The system as claimed in claim 1, further comprising a fixed force take-up ring, an inner radial surface of which, oriented toward the vertical axis of rotation, has channels cut into it, a wedge being held in each of these so as to be able to slide vertically.

11. The system as claimed in claim 1, wherein the captive nut comprises a head which projects beyond the cam surface of the wedge and which is held in an opening of the shoe bearing against this surface.

12. The system as claimed in claim 5, wherein the opening is created in the shoulder of the shoe and in that the localized direct bearing surface surrounds the mouth of the opening.

13. The system as claimed in claim 1, wherein two orifices are created in the wedge, which orifices are aligned with the larger dimension of the oblong opening, and in that the threaded rod engages successively in a first orifice of these two orifices, in an inner tapping of the captive nut and in the second orifice.

14. The system as claimed in claim 1, wherein the wedges, the captive nuts and the threaded rods associated with the various shoes are interchangeable.

15. An installation for converting hydraulic energy into electrical energy, or vice versa, comprising a wheel for a turbine, for a pump or for a pump turbine which is secured in rotation about a vertical axis with a shaft guided by shoes, and a system for guiding the shaft as claimed in claim 1.
